(19) United States
(12) Patent Application Publication
(10) Pub. No.: US 2004/0252315 A1
(43) Pub. Date: Dec. 16, 2004

(54) Print data formatting apparatus and method

(76) Inventor: Ki-min Kang, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/817,823

(22) Filed: Apr. 6, 2004

(30) Foreign Application Priority Data
Jun. 16, 2003 (KR) 2003-38785

(51) Int. Cl. G06F 3/12; H04N 1/034; H04N 1/21; G06F 12/02

(52) U.S. Cl. 358/1.8; 358/1.16; 358/502

(57) ABSTRACT

A print data formatting apparatus and corresponding method are disclosed comprising a unit band determination module for determining through a predetermined calculation process a unit band which is a unit for processing the unit block raster data, a receiver DMA module for receiving corresponding unit band raster data of the unit block raster data based on the determined unit band, a HV conversion module for converting the received unit band raster data into the slice data in rows and columns, a transmitter DMA module for transmitting the formed slice data to the external memory, and a nozzle buffer for storing the received unit band raster data and the formed slice data.

### CROSS-REFERENCE TO RELATED APPLICATION

This application claims the benefit of Korean Patent Application No. 2003-38785, filed Jun. 16, 2003, in the Korean Intellectual Property Office, the disclosure of which is incorporated herein by reference in its entirety.

### BACKGROUND OF THE INVENTION

1. Field of the Invention

The present invention relates to a print data formatting apparatus and method. More particularly, the present invention relates to a print data formatting apparatus and method capable of converting raster data to fit into a printer head structure and converting data with the certain number of memories regardless of the number of nozzles.

2. Description of the Related Art

In general, printer drivers have a font-processing module and an image-processing module to control printing operations. The image-processing module is divided into a vector module and a raster module (bitmap module). The vector module separates images prepared in a document into objects one by one, and generates each object as one command. The raster module formats the images into the raster data (bitmap data) and transfers the raster data to a printer, separately from the vector module. The transferred raster data is stored in an external memory provided in an inkjet printer, and is formatted by a print data formatting apparatus provided in the inkjet printer into slice data which corresponds to the respective nozzles of the printer head.

FIG. 1 is a block diagram illustrating a conventional print data formatting apparatus. FIG. 2 is a view illustrating the order in which the raster data stored by unit block in an external memory in general is transferred to the apparatus of FIG. 1. FIG. 3A is a view illustrating an N number of line unit raster data stored in a nozzle buffer, and FIG. 3B is a view illustrating an M number of slice data converted from the N number of bit unit line raster data of FIG. 3 through an HV conversion module, in which a slice data consists of N bits.

As shown in FIG. 1, a conventional print data formatting apparatus 10 has a receiver direct memory access (DMA) module 11, a nozzle buffer 12, a horizontal-vertical (HV) conversion module 13, and a transmitter DMA module 14. DMA modules control the exchange of memory between a main memory device and an I/O device. The raster data stored by unit block in the external memory 20 is received by the receiver DMA module 11. The print data formatting apparatus 10 has the receiver DMA module 11 receive, by a predetermined unit, the raster data transferred to an inkjet printer and stored in the external memory 20 in a direct memory access (DMA) mode. The present disclosure refers to such a predetermined unit as a unit block #1, #2, #3 and so on, as shown in FIG. 2. In order to simplify this discussion, it is assumed that one block read out and received by the receiver DMA module 11 has N M-bit unit line raster data. The ‘N’ is determined depending upon the number of nozzles of a printer head 30. The ‘N’ is proportional to the number of nozzles of the printer head 30.

The N M-bit unit line raster data included in the one block read out and received is stored in the nozzle buffer 12. The nozzle buffer 12 stores the N M-bit unit line raster data. A plurality of resistors are provided for the N M-bit unit line raster.

Since the print data formatting apparatus 10 is designed in one application specific integrated circuit (ASIC), however, it is preferable to minimize the size of the nozzle buffer 12. Therefore, it is preferable to limit the capacity of the nozzle buffer 12 to the size corresponding to one block of the receiver DMA module 11. Accordingly, it is assumed in this discussion that N resistors are provided.

The N M-bit unit line raster data stored in the nozzle buffer 12 is converted into an M N-bit slice data by the HV conversion module 13. As shown in FIGS. 3A and 3B, the slice data denotes data formed with bits corresponding to the same column in the respective raster data. The converted M N-bit slice data is re-stored in the nozzle buffer 12, and re-stored in the external memory 20 by the transmitter DMA module 14. The converted M N-bit slice data is applied to form print data images through the respective nozzles formed on the printer head 30 through a predetermined process.

FIG. 4 is a view illustrating individual bits of one slice data corresponding to individual nozzles of a printer head of FIG. 3B.

As shown in FIG. 4, the respective bits of each N-bit slice data generated through the HV conversion module 13 correspond and assigned to the respective nozzles provided on the printer head 30. If slice data bits are ‘1’, the corresponding nozzles fires ink, and, if slice data bits are ‘0’, the corresponding nozzles do not fire ink.

Recently developed inkjet printers have been highlighted as low-priced high-performance printers. Many different methods have been attempted to improve print speed, thereby upgrading the inkjet printers.

The increase in the number of nozzles, however, comes together with an increase in the number of corresponding slice data bits. With the increase in the number of slice data bits, the number of unit line raster data read out and transferred from the external memory has to correspondingly increase. Accordingly, the capacity of the nozzle buffer has to increase as well to store the raster data and the slice data. Since the data formatting apparatus is designed as one ASIC chip, however, a problem occurs in that as the capacity of the nozzle buffer becomes larger, the cost to manufacture the ASIC chip increases proportionally.

### SUMMARY OF THE INVENTION

In order to solve the above and other problems, it is an aspect of the present invention to provide a print data formatting apparatus and method for adjusting the size of raster data received for HV-conversions so that it is not necessary to increase the size of a nozzle buffer even when the number of nozzles of a printer head increases.

It is another aspect of the present invention to provide a print data formatting apparatus and method capable of HV-converting raster data of a predetermined size and adjusting memory addresses at which the converted raster data is stored.

In order to achieve the above aspects, a print data formatting apparatus according to a certain embodiment of the present invention comprises a unit band determination module for deciding, through a predetermined calculation process, a unit band which is a unit for processing the unit block raster data, a receiver DMA module for receiving corresponding unit band raster data of the unit block raster data based on the determined unit band, and an HV conversion module for converting the received unit band raster data into the slice data in rows and columns. The print data formatting apparatus further comprises a transmitter DMA module for transmitting the converted slice data to the external memory, and a nozzle buffer for storing the received unit band raster data and the converted slice data.

In an embodiment of the present invention, the number (P) of the unit band raster data determined for one unit block raster data is determined based on an equation of P=N/M, wherein M denotes the number of registers provided in the nozzle buffer and N denotes the number of printer head nozzles corresponding to the slice data. The print data formatting apparatus further comprises a memory address determination module for deciding, through a predetermined calculation process, memory addresses at which the converted slice data is stored. The transmitter DMA module transmits the slice data to the external memory based on the determined memory addresses.

In an embodiment of the present invention, the memory addresses ADDR are determined based on the following equation: ADDR=BASE_ADDR+{(BAND#−1)*ADDR_INC}+{(SLICE#−1)*ADDR_INC*p}. The BASE_ADDR denotes a starting point of a map of the external memory in which the slice data is stored. BASE_ADDR is updated to a next address of the recently stored memory address whenever slice data numbers are changed. BAND# denotes a number for the unit band raster data corresponding to one unit block raster data. ADDR_INC denotes a memory address increment amount, and SLICE# denotes a HV-converted slice number, and P denotes the number of unit band raster data determined for one unit block raster data.

In order to achieve the above and other aspects of the present invention, a print data formatting method for converting unit block raster data stored in an external memory of a printer and based on the number of printer head nozzles into slice data to be assigned to the respective printer head nozzles according to an embodiment of the present invention comprises deciding through a predetermined calculation process a unit band which is a unit for processing the unit block raster data, receiving corresponding unit band raster data of the unit block raster data based on the determined unit band, storing the received unit band raster data, and converting the stored unit band raster data into the slice data in rows and columns. The print data formatting method further comprises storing the converted slice data and transmitting the stored slice data to the external memory.

The print data formatting method according to an embodiment of the present invention further comprises deciding, through a predetermined calculation process, memory addresses at which the converted slice data is stored. The external memory transmission step transmits the slice data to the external memory based on the determined memory addresses.

The embodiments of the present invention do not need to replace the nozzle buffer even though the number of nozzles increases.

### BRIEF DESCRIPTION OF THE DRAWING FIGURES

The above aspects and other features of the present invention will become more apparent by describing in detail an illustrative, non-limiting embodiment thereof with reference to the attached drawing figures, and wherein:

FIG. 1 is a block diagram illustrating a conventional print data formatting apparatus;

FIG. 2 is a view illustrating the order in which unit block raster data stored in an external memory is transferred to the apparatus of FIG. 1;

FIG. 3A is a view illustrating N M-bit unit line raster data stored in a nozzle buffer;

FIG. 3B is a view illustrating the N M-bit unit line raster data of FIG. 3A converted to M N-bit slice data through a HV conversion module;

FIG. 4 is a view illustrating the individual bits of one slice data of FIG. 3B corresponding to the individual nozzles of a printer head;

FIG. 5 is a block diagram illustrating a print data formatting apparatus according to an embodiment of the present invention;

FIG. 6 is a view illustrating the order in which the unit block raster data stored in the external memory is transferred to the apparatus of FIG. 5 by four divided unit bands according to an embodiment of the present invention;

FIG. 7A is a view illustrating the N M-bit unit line raster data divided by four unit bands and stored in a nozzle buffer as L M-bit unit line raster data;

FIG. 7B is a view illustrating the L M-bit unit line raster data of FIG. 7B converted into M L-bit slice data through the HV conversion module;

FIG. 8 is a view illustrating external memory addresses and slice data stored at the memory addresses when the N M-bit unit line raster data of FIG. 7A is divided by four unit bands, HV-converted, and stored in the external memory;

FIG. 9A is a view illustrating the individual bits of the slice data of the first unit band in FIG. 7A corresponding to the individual nozzles of the printer head;

FIG. 9B is a view illustrating the individual bits of the slice data of the second unit band in FIG. 7B corresponding to the individual nozzles of the printer head;

FIG. 9C is a view illustrating the individual bits of the slice data of the third unit band in FIG. 7A corresponding to the individual nozzles of the printer head;

FIG. 9D is a view illustrating the individual bits of the slice data of the fourth unit band in FIG. 7A corresponding to the individual nozzles of the printer head; and

FIG. 10 is a flow chart illustrating a print data formatting method according to an embodiment of the present invention.

### DETAILED DESCRIPTION OF THE EMBODIMENTS

Hereinafter, descriptions will be made on a formatting apparatus and method according to an embodiment of the present invention with reference to the attached drawing figures.

FIG. 5 is a block diagram illustrating a print data formatting apparatus according to an embodiment of the present invention.

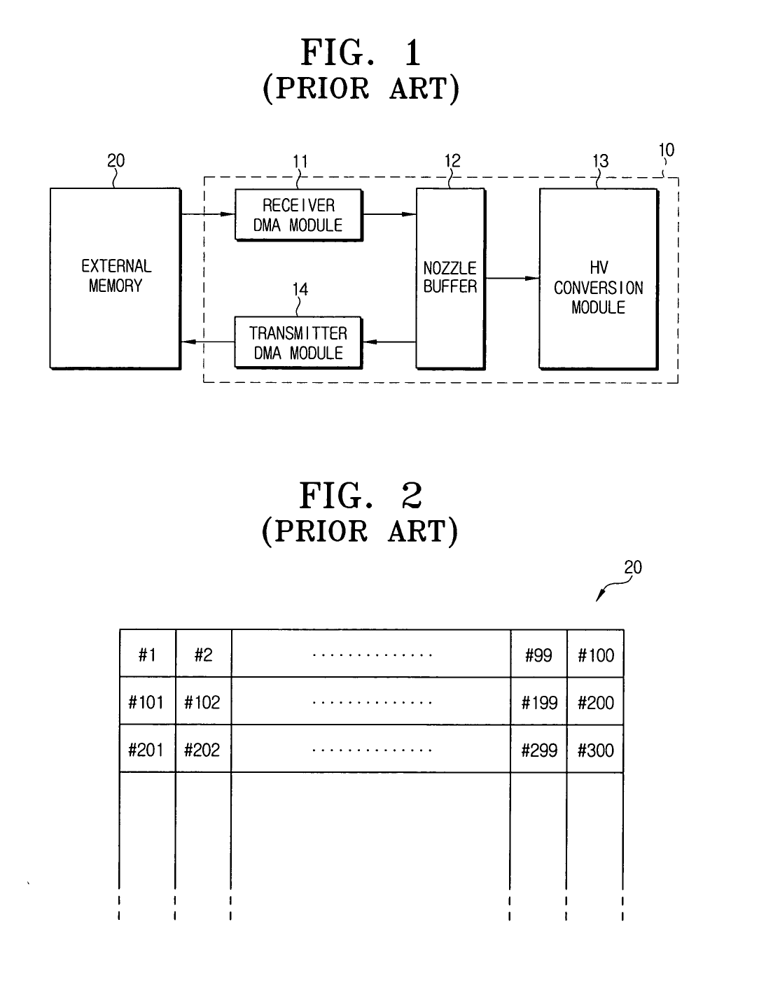

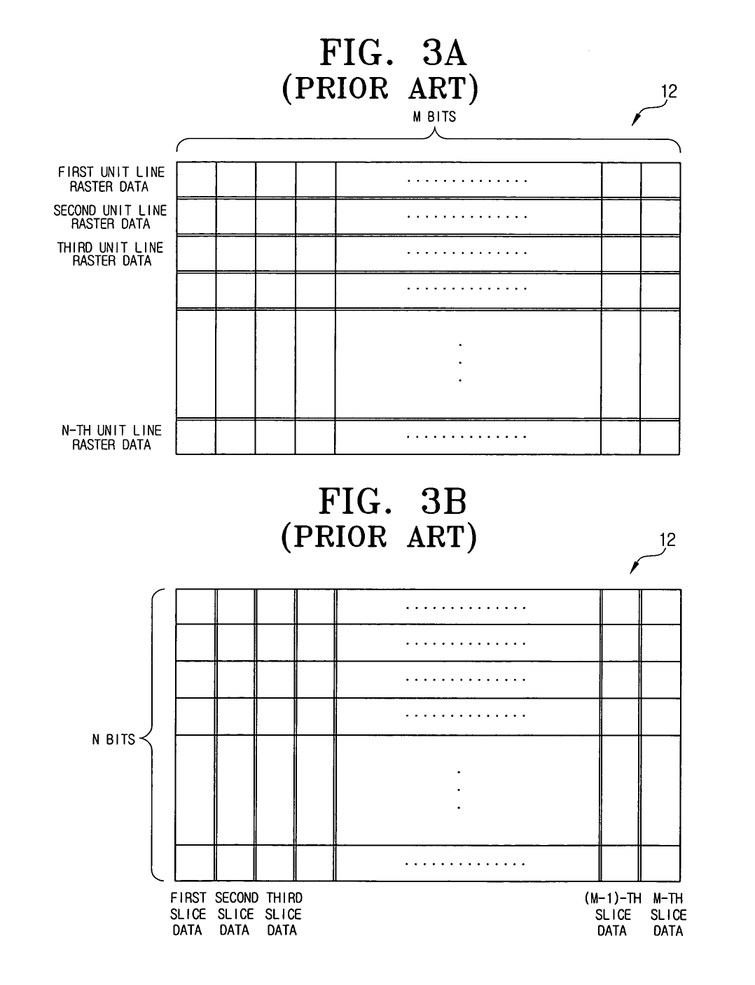

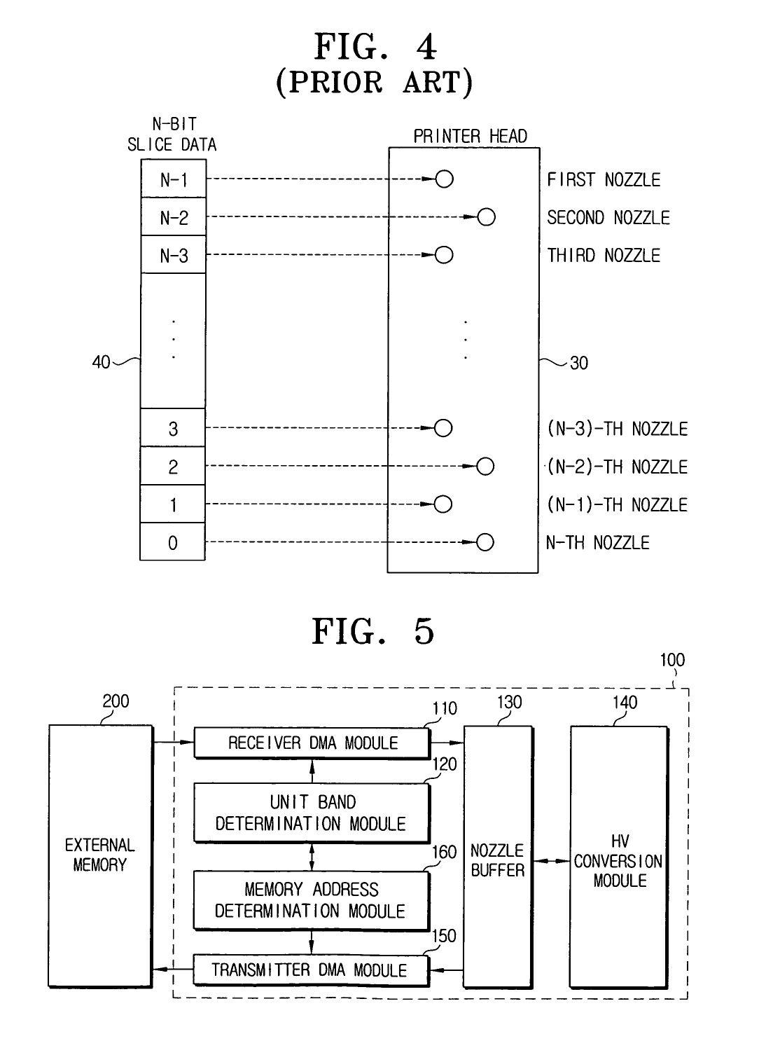

Referring to FIG. 5, a print data formatting apparatus 100 according to an embodiment of the present invention comprises a receiver DMA module 110, a unit band determination module 120, a nozzle buffer 130, an HV conversion module 140, a transmitter DMA module 150, and a memory address determination module 160. The receiver DMA module 110, nozzle buffer 130, HV conversion module 140, and transmitter DMA module 150 operate in the same manner as described in FIG. 1.

The print data formatting apparatus 100 further comprises the unit band determination module 120 connected to the receiver DMA module 110, and the memory address determination module 160 connected to the transmitter DMA module 150. The unit band determination module 120, according to an embodiment of the present invention, controls the receiver DMA module 110. The receiver DMA module 110 reads out and receives a part of unit block raster data which can be stored in the nozzle buffer 130 when reading out and receiving raster data stored in the external memory 200. The unit band determination module 120 determines a certain number (referred to as ‘L’ for convenience in this discussion) smaller than ‘N’ which is the number of unit line raster data formed in the unit block raster data. Accordingly, the receiver DMA module 110 reads out and receives the L unit line raster data from the unit block raster data. In this discussion, unit band raster data is the raster data in which the L unit line raster data is formed.

The number (P) of unit band raster data having the certain number (L) of lines smaller than the number (N) of the unit line raster data formed in the unit block raster data can be initially established by a user's definition, but, in accordance with an embodiment of the present invention, the number (P)is determined according to Equation 1, as below.

P=N/M Equation 1

In equation 1, M denotes the number of registers provided in the nozzle buffer 130, and N denotes the number of nozzles of a printer head corresponding to the slice data (i.e., the number of the unit line raster data formed in the unit block raster data).

In accordance with an embodiment of the present invention, the number (L) of the unit line raster data formed in the unit band raster data, is smaller than the number (N) of the unit line raster data formed in the unit block raster data and is the same as the number of registers in the nozzle buffer 130.

In order to use Equation 3 as below, the value P determined in the unit band determination module 120 is transferred to the memory address determination module 160.

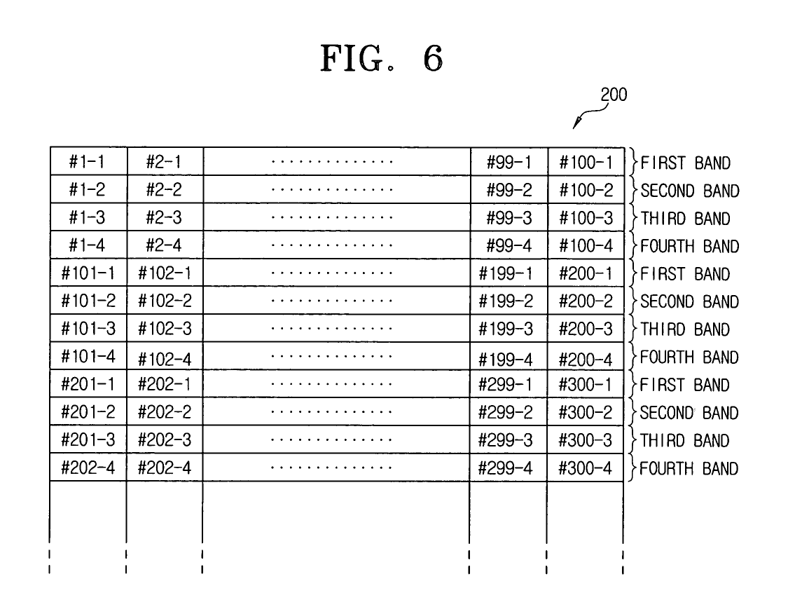

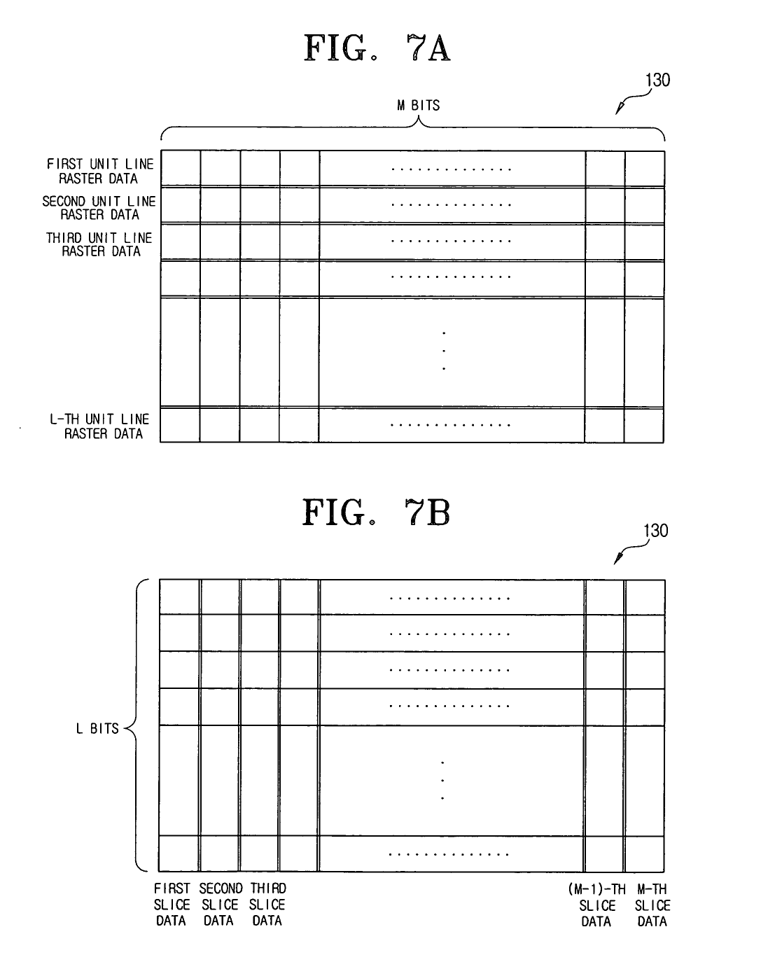

The print data formatting apparatus 100 according to an embodiment of the present invention further includes the memory address determination module 160. In operation, raster data is applied to the printer head 300. Unit block raster data controls the firings of nozzles is the. The unit readout of the receiver DMA module 110 according to the embodiment of the present invention, however, is not the unit block, but the unit band. Accordingly, the memory address determination module 160 compensates for different readouts from a stored state, which is described with reference to FIG. 6.

FIG. 6 is a view illustrating the order in which the unit block raster data stored in the external memory is divided by four unit bands and transmitted to the apparatus of FIG. 5 according to an embodiment of the present invention.

The unit block raster data is divided by four unit bands in an embodiment of the present invention. Specifically, the unit block raster data #1 of FIG. 2 is divided into unit band raster data #1-1, #1-2, #1-3, and #1-4 as shown in FIG. 6. This does not mean, however, that the unit block raster data is actually divided into the four unit bands, but indicates that the receiver DMA module 110 reads out as much raster data as shown in the unit band. The receiver DMA module 110 reads out data in the order of #1-1, #2-1, #3-1, . . . , #99-1, #100-1, #1-2, #2-2, and so on.

The raster data is stored in the external memory 200 and assigned to the printer head 300 to control firing of the nozzles by the unit block, under consideration of which the slice data is stored in the order of #1-1-1, #1-2-1, #1-3-1, #1-4-1, #1-1-2, #1-2-2, #1-3-2, #1-4-2, #1-1-3, #1-2-3, . . . The first number ‘1’ of the ‘#1-1-1’ denotes a block number, the second number ‘1’ denotes a band number, and the third number ‘1’ denotes a slice data number.

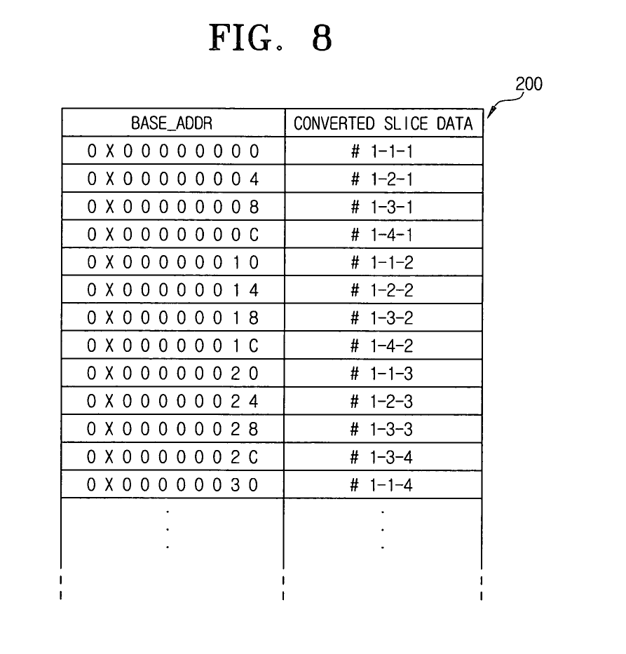

In order to compensate for the differences, it is necessary to adjust the memory addresses at which the slice data of the unit band raster data is stored. According to an embodiment of the present invention, the memory address determination module 160 determines the memory addresses at which slice data is stored, and controls the transmitter DMA module 150. The operations of the transmitter DMA module 150 related to the operations of the memory address determination module 160 are described with reference to FIG. 8.

FIG. 7A is a view illustrating the N M-bit unit line raster data divided by four unit bands and stored in a nozzle buffer as an L M-bit unit line raster data, and FIG. 7B is a view illustrating the L M-bit unit line raster data of FIG. 7A converted into M L-bit slice data through the HV conversion module.

As described above, the unit band raster data forming the L M-bit unit line raster data is stored in the nozzle buffer 130 through the receiver DMA module 110, the stored unit band raster data is then converted into the M L-bit slice data by the HV conversion module 140, and the converted slice data is re-stored in the nozzle buffer 130.

FIG. 8 is a view illustrating the order in which the print data formatting apparatus re-stores slice data corresponding to the unit block raster data in the external memory.

Referring to FIG. 6, the unit band raster data is read out and received in the nozzle buffer 130 in the order of #1-1, #2-1, #3-1, . . . through the receiver DMA module 110, and the unit band raster data is then HV-converted into slice data in the same order through the HV conversion module 140. The slice data is re-stored in the external memory 200 in the above order, and assigned to individual nozzles through a predetermined process.

If the converted slice data is stored in the external memory 200, the slice data is stored in turn in the order of #1-1-1, #1-1-2, #1-1-3, and #1-1-4. In order to properly print an image based on print data, however, the converted slice data is stored in the order of #1-1-1, #1-2-1, #1-3-1, #1-4-1, #1-1-2, #1-2-2, #1-3-2, #1-4-2, #1-1-3, and #1-2-3, as shown in FIG. 8, and stored at memory addresses fit to the order by the transmitter DMA module 150. Accordingly, the memory address determination module 160 assigns predetermined memory addresses to respective slice data in order for the transmitter DMA module 150 to precisely re-store the HV-converted slice data to the memory addresses of the external memory 200. Specifically, the slice data is not stored in turn in correspondence to the converted order, but stored at the memory addresses fit to the image based on the print data. (i.e., the memory addresses determined by the memory address determination module 160).

In Equations 2 and 3 (described below), the BASE_ADDR denotes a start point of a map of the external memory 200 in which the slice data is stored, and the BAND# denotes a number for the unit band raster data corresponding to one unit block raster data. ADDR_INC denotes a memory address increment amount, and SLICE# denotes a HV-converted slice number. The memory address, ADDR, at which unit band-processed slice data is stored, is determined in Equations 2 and 3.

START_ADDR=BASE_ADDR+{(BAND#−1)*ADDR_INC} Equation 1

ADDR=START_ADDR+{(SLICE#−1)*ADDR_INC*P} Equation 3

The START_ADDR is calculated in Equation 2, and then is applied in Equation 3. In the embodiment of the present invention as illustrated in FIG. 8, the ADDR_INC is ‘0X00000004’, and the BASE_ADDR is initially set to ‘0X00000000’. As described above, the value of P is a value determined by the unit band determination module 160.

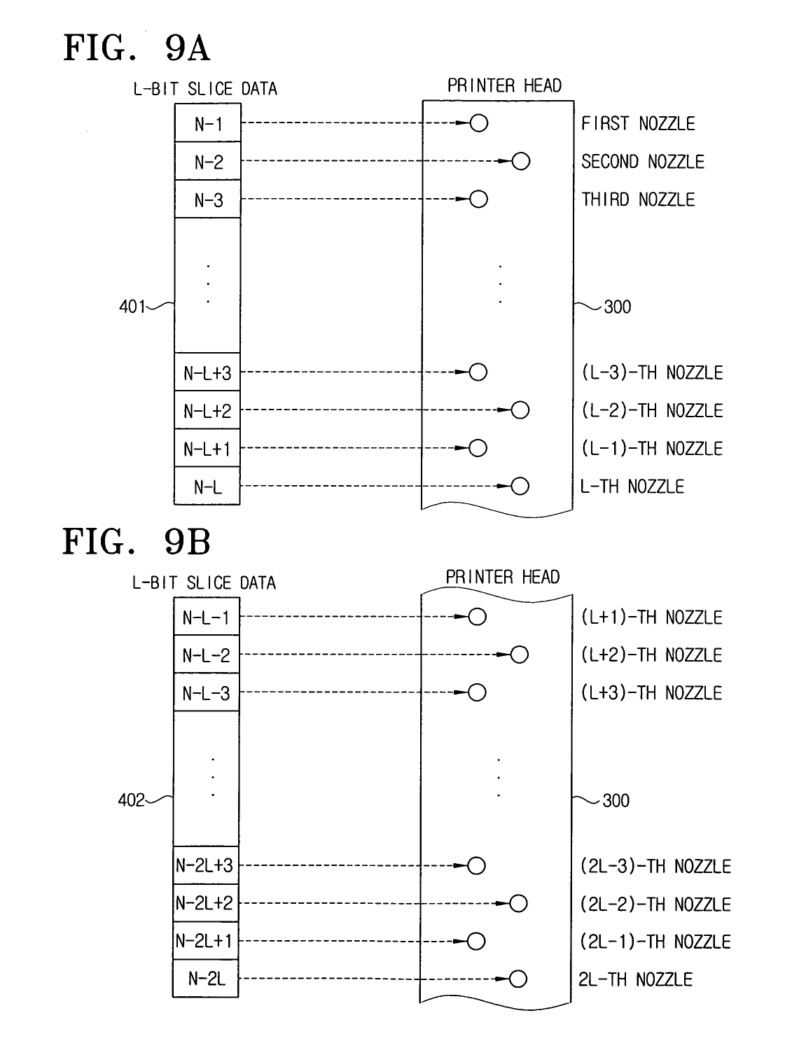

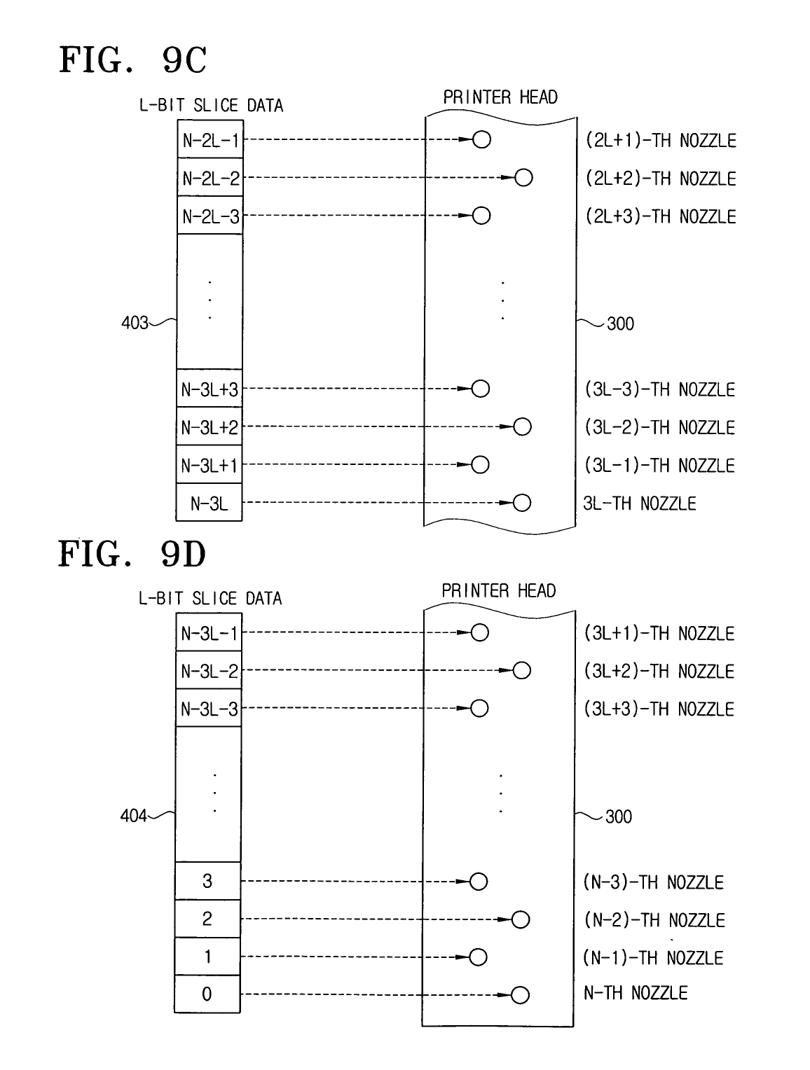

FIGS. 9A through 9D show that the unit block raster data is divided into the unit band raster data as in FIGS. 6 through 7B, and the respective slice data bits of the divided unit band raster data correspond to the respective nozzles provided on the printer head 300.

Since the memory addresses of the external memory 200 are separately determined as in FIG. 8 even though the raster data is processed in the certain number of unit bands according to an embodiment of the present invention, an identical result as the slice data bits being assigned to the N nozzles of the printer head 300 can be obtained when the unit block raster data is converted through the HV conversion module 140 to form the slice data.

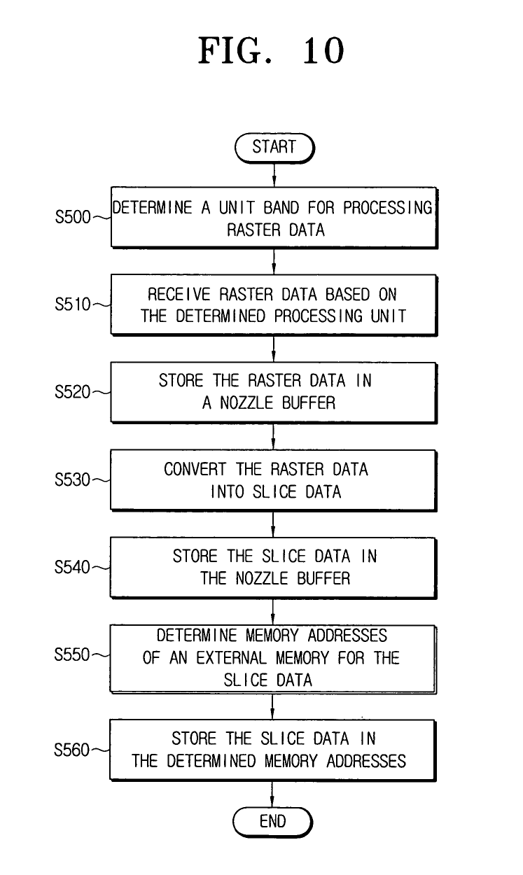

FIG. 10 is a flow chart illustrating a print data formatting method according to an embodiment of the present invention.

Initially, print data is stored in the external memory 200 in the form of the unit block raster data through a predetermined process. The unit band determination module 120 then determines, at step S500, the number of unit bands into which the unit block raster data is to be divided in consideration of the number of registers in the nozzle buffer 130. In step S510 the receiver DMA module 110 reads out and receives the unit band raster data from the external memory 200 by the unit band determined in the unit band determination module 120. The received unit band raster data is stored in the nozzle buffer 130 at step S520. In step S530 the unit band raster data stored in the nozzle buffer 130 is HV-converted into slice data through the HV conversion module 140. The converted slice data is temporarily re-stored in the nozzle buffer 130 +at step S540. The memory address determination module 160 then determines the memory addresses at which the temporarily stored slice data is stored in the external memory 200 at step S550. In step S560, the transmitter DMA module 150 stores the converted slice data in the external memory 200 based on the memory address determined in the memory address determination module 160 during the previous step, step S550. Hence, even though the number of nozzles increases the number of the HV-converted unit line raster data is adjusted, and there is no need to increase the capacity of the nozzle buffer 130.

The print data formatting apparatus and method according to the embodiment of the present invention has an advantage in that there is no need to separately update the nozzle buffer to a larger capacity even when the number of printer head nozzles increases to print data more rapidly. Furthermore, the embodiment of the present invention does not require the replacement of the nozzle buffer even when a printer head having a greater number of nozzles is employed, thereby eliminating the problem of replacing an entire chip as well as the nozzle buffer in a print data formatting apparatus designed based on use of an ASIC.

While the embodiment of the present invention have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the invention.

What is claimed is:

1. A print data formatting apparatus for converting unit block raster data stored in an external memory of a printer and based on the number of printer head nozzles into slice data to be assigned to the respective printer head nozzles, comprising:
a unit band determination module for determining through a predetermined calculation process a unit band which is a unit for processing the unit block raster data;
a receiver DMA module for receiving corresponding unit band raster data of the unit block raster data based on the determined unit band;
a HV conversion module for converting the received unit band raster data into slice data in rows and columns;
a transmitter DMA module for transmitting the converted slice data to the external memory; and
a nozzle buffer for storing the received unit band raster data and the converted slice data.

2. The print data formatting apparatus as claimed in claim 1, further comprising:
the unit band determination module determining a number (P) of the unit band raster data for one unit block raster data based on an equation as below:
P=N/M,
wherein, M denotes the number of registers provided in the nozzle buffer and N denotes the number of printer head nozzles corresponding to the slice data.

3. The print data formatting apparatus as claimed in claim 2, further comprising:
a memory address determination module for determining through a predetermined calculation process memory addresses ADDR at which the converted slice data is stored, wherein the transmitter DMA module transmits the slice data to the external memory based on the determined memory addresses.

4. The print data formatting apparatus as claimed in claim 3, wherein the step of determining the memory addresses ADDR comprises:
determining the memory addresses ADDR based on an equation:
ADDR=BASE_ADDR+{(BAND#−1)*ADDR_INC}+{(SLICE#−1)*ADDR_INC*p},
wherein, the BASE_ADDR denotes a starting point of a map of the external memory in which the slice data is stored and is updated to a next address of the recently stored memory address whenever slice data numbers are changed, the BAND# denotes a number for the unit band raster data corresponding to one unit block raster data, the ADDR_INC denotes a memory address increment amount, and the SLICE# denotes a HV-converted slice number.

5. A print data formatting method for converting unit block raster data stored in an external memory of a printer and based on the number of printer head nozzles into slice data to be assigned to the respective printer head nozzles, comprising:
determining through a predetermined calculation process a unit band which is a unit for processing the unit block raster data;
receiving corresponding unit band raster data of the unit block raster data based on the determined unit band;
storing the received unit band raster data;
converting the stored unit band raster data into the slice data in rows and columns;
storing the converted slice data; and
transmitting the stored slice data to the external memory.

6. The print data formatting method as claimed in claim 5, wherein the step of determining through a predetermined calculation process a unit band comprises:
determining a number (P) of the unit band raster data for one unit block raster data based on an equation:
P=N/M,
wherein, M denotes the number of registers provided in the nozzle buffer and N denotes the number of printer head nozzles corresponding to the slice data.

7. The print data formatting method as claimed in claim 6, further comprising:
deciding through a predetermined calculation process memory addresses ADDR at which the converted slice data is stored, wherein in the step of transmitting the stored slice data to the external memory, the slice data is transmitted to the external memory based on the determined memory addresses.

8. The print data formatting method as claimed in claim 7, wherein the step of deciding the memory addresses ADDR comprises:
determining the memory addresses ADDR based on an equation:
ADDR=BASE_ADDR+{(BAND#−1)*ADDR_INC}+{(SLICE#−1)*ADDR_INC*p},
wherein, the BASE_ADDR denotes a starting point of a map of the external memory in which the slice data is stored and is updated to a next address of the recently stored memory address whenever slice data numbers are changed, the BAND# denotes a number for the unit band raster data corresponding to one unit block raster data, the ADDR_INC denotes a memory address increment amount, and the SLICE# denotes a HV-converted slice number.

9. A computer-readable medium encoded with a computer program for print data formatting that converts unit block raster data that is stored in an external memory of a printer and is based on the number of printer head nozzles into slice data to be assigned to the respective printer head nozzles, comprising:
program code for determining through a predetermined calculation process a unit band which is a unit for processing the unit block raster data;
program code for receiving corresponding unit band raster data of the unit block raster data based on the determined unit band;
program code for storing the received unit band raster data;
program code for converting the stored unit band raster data into the slice data in rows and columns;
program code for storing the converted slice data; and
program code for transmitting the stored slice data to the external memory.

10. The computer-readable medium as claimed in claim 9, further comprising:
the program code for determining a number (P) of the unit band raster data for one unit block raster data based on an equation as below:
P=N/M,
wherein, M denotes the number of registers provided in the nozzle buffer and N denotes the number of printer head nozzles corresponding to the slice data.

11. The computer-readable medium as claimed in claim 10, further comprising:
program code for determining through a predetermined calculation process memory addresses ADDR at which the converted slice data is stored, wherein the transmitter DMA module transmits the slice data to the external memory based on the determined memory addresses.

12. The computer-readable medium as claimed in claim 11, wherein the program code for determining the memory addresses ADDR comprises:
program code for determining the memory addresses ADDR based on an equation:
ADDR=BASE_ADDR+{(BAND#−1)*ADDR_INC}+{(SLICE#−1)*ADDR_INC*P},
wherein, the BASE_ADDR denotes a starting point of a map of the external memory in which the slice data is stored and is updated to a next address of the recently stored memory address whenever slice data numbers are changed, the BAND# denotes a number for the unit band raster data corresponding to one unit block raster data, the ADDR_INC denotes a memory address increment amount, and the SLICE# denotes a HV-converted slice number.

13. A computer-readable medium encoded with a computer program for print data formatting that converts unit block raster data that is stored in an external memory of a printer and is based on the number of printer head nozzles into slice data to be assigned to the respective printer head nozzles, comprising:
program code for determining through a predetermined calculation process a unit band which is a unit for processing the unit block raster data;
program code receiving corresponding unit band raster data of the unit block raster data based on the determined unit band;
program code storing the received unit band raster data;
program code converting the stored unit band raster data into the slice data in rows and columns;
program code storing the converted slice data; and
program code transmitting the stored slice data to the external memory.

14. The computer-readable medium as claimed in claim 13, wherein the program code for determining through a predetermined calculation process a unit band comprises:
program code for determining a number (P) of the unit band raster data for one unit block raster data based on an equation:
P=N/M,
wherein, M denotes the number of registers provided in the nozzle buffer and N denotes the number of printer head nozzles corresponding to the slice data.

15. The computer-readable medium as claimed in claim 14, further comprising:
program code deciding through a predetermined calculation process memory addresses ADDR at which the converted slice data is stored, wherein in the step of transmitting the stored slice data to the external memory, the slice data is transmitted to the external memory based on the determined memory addresses.

16. The computer-readable medium as claimed in claim 15, wherein the program code for deciding the memory addresses ADDR comprises:
program code for determining the memory addresses ADDR based on an equation:
ADDR=BASE_ADDR+{(BAND#−1)*ADDR_INC}+{(SLICE#−1)*ADDR_INC*p},
wherein, the BASE_ADDR denotes a starting point of a map of the external memory in which the slice data is stored and is updated to a next address of the recently stored memory address whenever slice data numbers are changed, the BAND# denotes a number for the unit band raster data corresponding to one unit block raster data, the ADDR_INC denotes a memory address increment amount, and the SLICE# denotes a HV-converted slice number.
